(19) United States
(12) Patent Application Publication
(10) Pub. No.: US 2003/0208144 A1
(43) Pub. Date: Nov. 6, 2003

(54) Massaging device

(76) Inventors: Svein Inge Sorlie, Goldcoast (AU); Jon Lewis-Jonsson, Helsingborg (SE)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/136,886

(22) Filed: May 1, 2002

(51) Int. Cl. A61H 7/00

(52) U.S. Cl. 601/137

(57) ABSTRACT

The present invention for a massaging device comprises a plurality of resilient first members and a plurality of resilient second members. Each first member and second member has a fixed end connected to a handle. The first members each have a free end distal the fixed. The second members similarly have free ends distal the fixed ends, and the free ends on the second members are spaced apart from the free ends on the first members toward the handle.

### BACKGROUND OF THE INVENTION

The present invention relates in general to devices used for massaging areas of one's body, and in particular to the head, neck, and back areas of the body. More specifically, the present invention relates to such massaging devices that are manually operated.

A wide variety of devices exist for massaging different areas of one's body. Many of these devices oscillate or vibrate by an automated means for massaging parts of the body when contacted. Other devices are manually manipulated, and require a user to apply pressure to the device, rubbing the device in a back and forth motion to effect massaging.

One such manually operated device is disclosed in the U.S. Pat. No. 6,309,365 (the “'365 Patent”) for A Head Massaging Device, issued to Dwayne Lacey, Hilton, Western Australia. The device disclosed in the '365 patent comprises a handle, and a plurality of resilient “fingers” that define a head receiving space. An opening is formed at end of the fingers by the relative juxtaposition of the free ends of the fingers. The fingers are conformed so the opening is smaller than the head of a person, so the free ends of the fingers contact the head and apply pressure to the head. A user massages the head by raising and lowering the device over the head, and rotating the device. However, the above-described device does not provide a means for massaging the crown of the head while the remaining portion of the head is being massaged.

### SUMMARY OF THE INVENTION

The present invention for a massaging device comprises a plurality of resilient first members and a plurality of resilient second members. In a preferred embodiment, each of the first members have a given length, and each of the second members has a given length that is shorter than the length of each first member. Thus, each respective first member and second member has a free end distal to a fixed end whereby the free end on each second member is spaced above the free end of each first member.

In an embodiment of the invention, the first members are spaced apart, defining an area therebetween. At least a portion of each second member extends within the area defined by the first members. In addition, the free ends of the first member are arranged to form a first opening, and said first members define an outermost periphery. The free ends of the second members are arranged to form a second opening spaced above the first opening and within the outermost periphery defined by the first members.

### BRIEF DESCRIPTION OF THE DRAWINGS

FIG. 1 is a perspective view of a first embodiment of the present invention.

FIG. 2 is a perspective view of a second embodiment of the present invention.

FIG. 3 is the perspective view of the present invention collapsed in a storage position.

FIG. 4 is a view of the present invention applied to a person's back.

FIG. 5 is a side view of a third embodiment of the present invention.

### DETAILED DESCRIPTION OF THE DRAWINGS

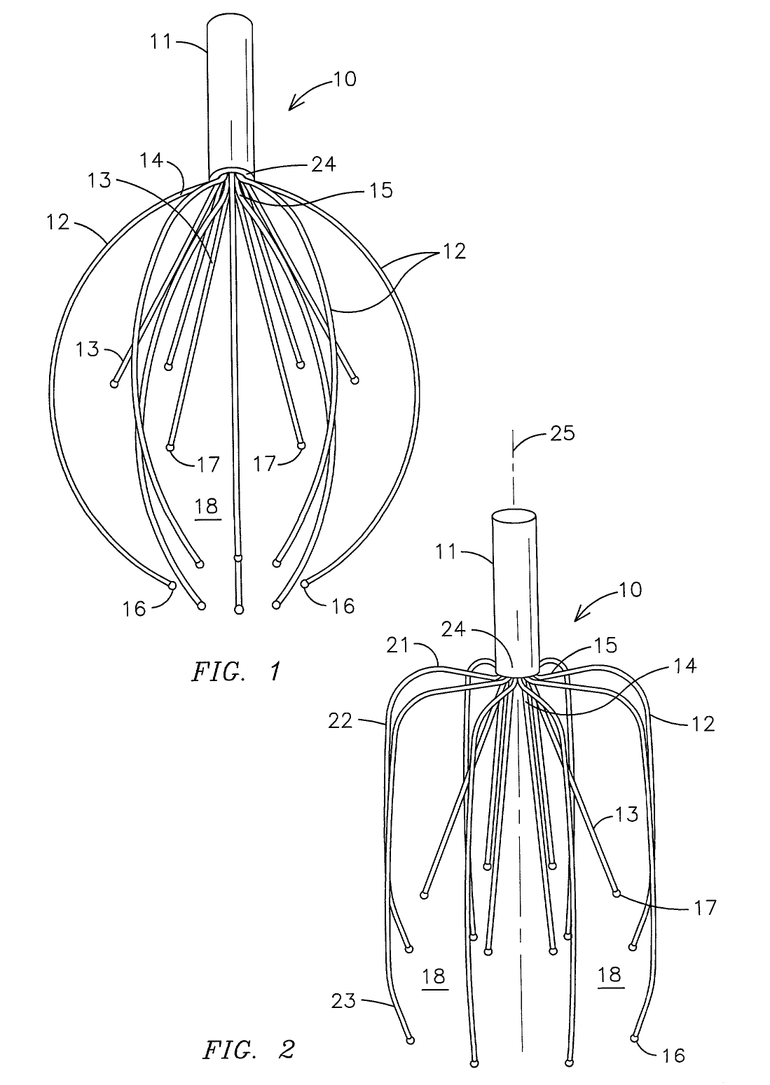

Different embodiments of the invention are shown in FIGS. 1, 2 and 3. With respect to the embodiments of FIGS. 1 and 2, the massaging device 10 comprises a plurality of resilient first members 12 spaced apart, forming an area 18 therebetween. The first members 12 are preferably constructed of a soft metal such as copper or aluminum so the members are pliable to bend and manipulate the members to a desired configuration. The first members 12 may be fabricated from other materials such as plastics and/or may be jointed to shape the members 12.

As shown in FIGS. 1, 2 and 3 each of the first members 12 has a fixed end 14 attached to a handle 11. The fixed ends 14 can be secured in any number of manners. Typically wire members can be bundled or coiled together, and enclosed within a sheath member (not shown) to secure the fixed ends together. A handle 11 is fitted over the fixed ends 14. The handle 24 may be constructed from any lightweight structurally sound material as metal, wood or plastic.

With respect to FIGS. 1 and 2, the members 12 extend radially outward and downward from a base 24 of the handle 11, and are spaced apart forming an area 18 intermediate the first members 12. Each first member 12 has a free end 16, distal the fixed end 14, which free ends 16 are positioned to form a first opening 19. When the massaging device 10 is used, the free ends 16 of the first members 12 contact the head or scalp or other body parts and apply pressure. The handle 11 is grasped, lowering the device over the head, then raised and lowered to massage a desired area.

The massaging device 10 also comprises a plurality of resilient second members 13. The second members 13 are preferably fabricated from the same material used to make the first member 12. At least a portion of each second member 13 is disposed within the area 18 intermediate the first members 12. The second members 13 similarly have a fixed end 15 secured within the handle 24, as described above. As shown in FIGS. 1, 2 and 3, each second member 13 has a free end 17 distal the fixed end 15. The free ends 17 are spaced above the free ends 16 of the first members 12. The term “spaced above” or “spaced apart” includes any direction of spacing, which may be dependent on the position of the handle and free ends 16 and 17. Thus, if the device in FIGS. 1 and 2 is inverted, the free ends 17 may be spaced below the free ends 16, but the terms “spaced above” and “spaced apart” include such a configuration.

With respect to the embodiments shown in FIGS. 1 and 2, the free ends 17 of the second members are positioned within the area 18 forming a second opening 20 spaced above the first opening 19, and within an outermost periphery of the first members 12. The spacing of the free ends 17 of the second members 13 from the free ends 16 of the first members 12, may be facilitated by providing the second members 13 having a shorter length than the length of the first members 12.

In use, the massaging device 10 is lowered over a person's head. The free ends 16 of the first member 12 contact sides of the head and the free ends 17 of the first member 13 contacts the top or crown of the head. The handle is moved up and down, massaging both the sides and top of the head.

With respect to FIG. 2, a second embodiment is shown in which first members 12 are bent to enhance the massaging on the head. The first member 12 has a first section 21, which extends laterally from the base 24 of the handle 11 and substantially perpendicular to a longitudinal axis 25 of the handle 11. A second section 21 extends downward from the first section 21 terminating at a third section 23. The third sections 23 are angled toward the longitudinal axis 25 of the handle. The third section 23 is preferably disposed at an able obtuse relative to the second section 22. In this manner, a terminus of each free end 17 directly contacts the head.

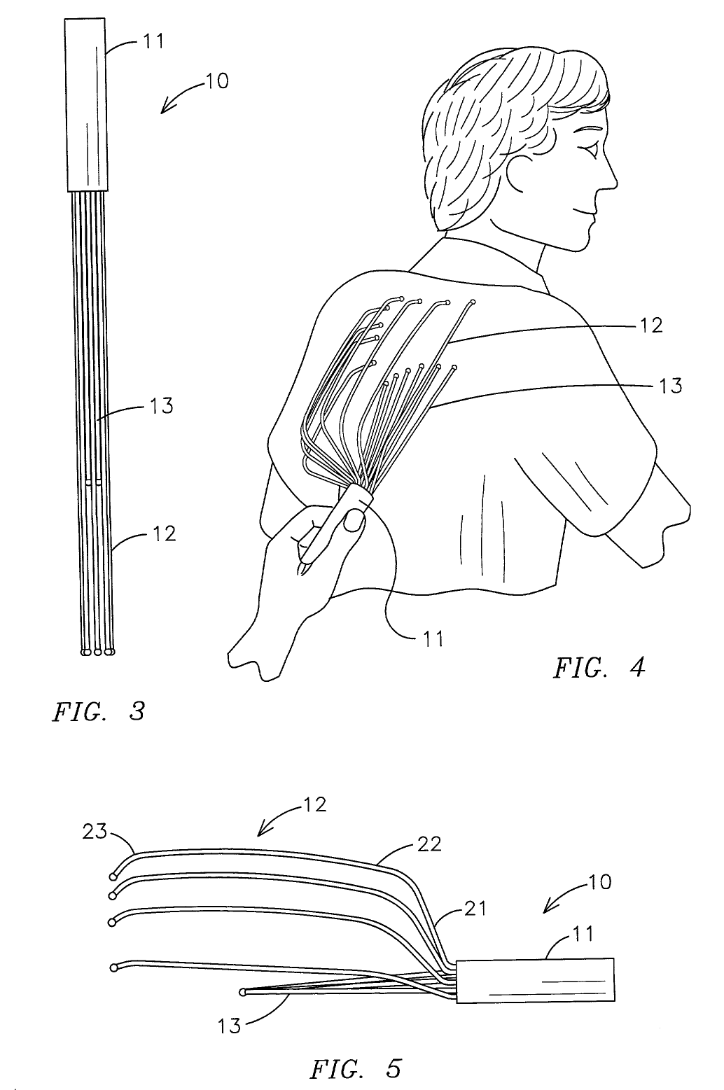

In FIGS. 4 and 5, the massaging device 10 is shown with the members 12 and 14 arranged for application the neck and back of a person. In this particular embodiment the first members 12 may be arranged in a substantially planar arrangement, or in the curvilinear arrangement shown in FIG. 3. In addition, the first members 12 are bent to form the three sections 21, 22 and 23, as described above. The free ends 17 of the second members 13 are positioned such that the free ends 17 are spaced apart from the free ends 16 of the first members 12. The second members 12 may be arranged in a desired fashion such as the planar arrangement shown in FIG. 3, or such that the free ends 16 and 17 are in a coplanar juxtaposition. Alternatively, the second members 13, and their free ends 17, may be spaced laterally from the first members 12 and the free ends 17 thereof.

With respect to FIG. 3, the members 12 and 13 are collapsed in a substantially cylindrical form so the massaging device can be packaged in a tube. The members 12 and 13 may be arranged in a variety of configurations to accommodate its packaging. Because the members are pliable, the members are adjusted to an arrangement for massaging parts of the body when removed from packaging (not shown).

While the preferred embodiments of the present invention have been shown and described herein in this context, it will be obvious that such embodiments are provided by way of example only and not of limitation. Numerous variations, changes and substitutions will occur to those of skilled in the art without departing from the invention herein. Accordingly, it is intended that the invention be limited only by the spirit and scope of the appended claims.

What we claim as our invention is:

1. A massaging device, comprising:
(a) a plurality of resilient first members spaced apart defining an area intermediate the first members, and each said first member having a fixed end distal to a free end thereof, and,
(b) a plurality of resilient second members, and at least a portion of each said second member extending within said area intermediate the first members, and each said second member having a fixed end, and a free end distal to the fixed end, and disposed within said area spaced apart from each free end on a respective first members.

2. The massaging device claim 1 further comprising a handle to which the fixed end of each first member, and the fixed end of each second member, is connected.

3. The massaging device of claim 1 wherein each said first member has a given length, and each said second member has a given length that is shorter than the given length of each said first member.

4. The massaging device of claim 1 further comprising a handle to which the fixed end of each first member, and the fixed end of each second member, is attached and said first members having a length extending from a base of the handle to the free end of each respective first member, and each said second member having a length extending from a base of the handle that is shorter than the length of each respective first member.

5. The massaging device of claim 1 wherein the free ends of the first members define a first opening, and the free ends of the second members define a second opening spaced apart from said first opening.

6. The massaging device of claim 1 wherein said first members are conformed in an arrangement having an outermost periphery, and the free ends of the second members define an opening within said outermost periphery defined by said first members.

7. A massaging device, comprising:
(a) a handle having a longitudinal axis;
(b) a plurality of resilient first members attached to said handle and each said first member having a first section extending transversely with respect to the longitudinal axis and radially outward from a base of said handle;
(c) a second section of each first member connected to the first section and extending substantially perpendicular thereto, and substantially parallel to the longitudinal axis;
(d) a third section of each first member, connected to the second section, disposed at an angle with respect to the second section, and extending toward the longitudinal axis of the handle; and,
(e) a free end on each said first member.

8. The massaging device of claim 7 further comprising a plurality of resilient second members attached to said handle, and extending outward from a base of the handle, and each said second member having a free end spaced apart from the free end of each respective first member.

9. The massaging device of claim 7 wherein said first members are spaced apart forming an area intermediate the first members, and said free ends of the respective first members define a first opening, and said device further comprising a plurality of resilient second members attached to said handle, and extending downward from a base of the handle, wherein at least a portion of each second member is disposed within the area intermediate the first members, and each said second member having a free end which form a second opening spaced apart from said first opening.

10. A massaging device, comprising:
(a) a handle;
(b) a plurality of resilient first members having a fixed end connected to the handle and extending therefrom, and a free end distal to the fixed end; and,
(c) a plurality of resilient second members having a fixed end connected to the handle and extending therefrom, and a free end, distal to the fixed end, and said free ends of the second members spaced apart from the free ends on first members toward said handle.

10. The massaging device of claim 10 wherein said first members have a given length from said handle to the free end thereof, and each said second member has a given length from the handle to the free end thereof that is shorter than the length of each said first member.

11. The massaging device of claim 10 wherein the given length of each of the first members is substantially the same and the given length of each of the second members is substantially the same.

12. The massaging device of claim 10 wherein said first members are aligned with respect to one another and said second members are aligned with respect to one another, and said second members are spaced laterally with respect to the first members.

13. The massaging device of claim 10 wherein said first members are spaced apart defining an area intermediate the first members, and at least a portion of each second member is disposed within said area intermediate the first members.

14. The massaging device of claim 10 wherein said device has an outermost periphery defined by the first members, the free ends of the first member are positioned forming a first opening and the free ends of said second members are positioned forming a second opening spaced apart from the first opening toward the handle and within the outermost periphery of the device.
